(19) United States
(12) Patent Application Publication
(10) Pub. No.: US 2007/0047919 A1
(43) Pub. Date: Mar. 1, 2007

(54) Video encoding device

(75) Inventors: Daisuke Yoshida, Tokyo (JP); Keisuke Inata, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/502,591

(22) Filed: Aug. 9, 2006

(30) Foreign Application Priority Data
May 13, 2005 (JP) 2005-140580

(51) Int. Cl. H04N 7/26

(52) U.S. Cl. 386/112

(57) ABSTRACT

A video encoding device capable of recording a plurality of videos at the same time is provided. It is a device capable of performing simultaneous compression encoding and recording of programs of at least one or more channels selected by using, for example, a video encoding method such as an MPEG-2 format, comprises an antenna, a tuner unit, a synchronizing signal generating unit, a recording channel control unit, a multichannel encoder, a recording unit, a monitor, a loudspeaker, a GUI and an overall control unit, and controls the recording channel control unit so that the encoding processing by the multichannel encoder is decreased.

### BACKGROUND OF THE INVENTION

The present invention relates to a video encoding device and method for compression encoding of certain video data according to a prescribed method.

As a background art of this technical field, there is, for example, JP-A-2002-232884. This publication describes, “It provides an image encoding device that can perform a plurality of encoding independently under different conditions and can be realized at a low cost” as an object. As a resolution approach, it describes, “A first encoding control unit 108 and a second encoding control unit 109 each perform encoding control of images stored in a first encoding object image storage unit 100 and a second encoding object image storage unit 101 and perform encoding processing by an encoding unit 102. At this time, a time division encoding control unit 110 controls to enable to perform time division processing of encoding and realizes a plurality of encoding at the same time. To perform encoding under different conditions, a first encoding information storage unit 106 and a second encoding information storage unit 107 store only required parameters, and a common encoding data storage unit 105 stores other information, and a memory area is shared.”

As another background art, there is JP-A-08-181994. This publication describes its object as “To provide a video encoding device capable of encoding by multiplexing a plurality of image sources.” and provides an effect, “A plurality of video signals can be encoded by multiplexing, and identification information for identification of each video signal is added to encoding information to be output, so that when encoding, individual video signals can be subjected to decoding processing separately according to identification information of the encoding information, and the plurality of video signals can be encoded appropriately by a single video encoding device.”

### SUMMARY OF THE INVENTION

According to development of video processing technologies in these years, it is general to record and store video information by digitizing and to provide it for viewing. For example, household camcorders, HDD/DVD recorders, streaming broadcastings over the Internet and the like are good examples.

Here, a video data amount becomes considerably large, so that digitized video data is mostly compression-encoded for handling. There are various compression encoding methods, and MPEG-2, MPEG-4, H.264/AVC and other methods are enacted as international standard methods. An optimum one is selected depending on the usage from many video encoding methods. For example, MPEG-2 is used when video is recorded on a DVD. And, MPEG-4 is mostly used for delivery of images over the Internet. Besides, it has been decided to use MPEG-2 and H.264/AVC for next-generation optical disks such as Blu-ray and HD-DVDs.

The hard disk and DVD are random accessable media, so that when video is encoded and recorded by a HDD/DVD recorder, a plurality of video encoding devices (encoders) can be used to encode video data of a plurality of channels at the same time and to record on the hard disk at the same time.

However, according to the above method, the upper limit of the number of channels recordable at the same time depends on the number of encoders mounted, and no more larger number of channels can be recorded at the same time. Therefore, if it becomes suddenly necessary to record another channel when all the encoders are being used for recording, it is necessary to stop any of the current recording of channels and to add the channel.

And, a circuit scale is large when the encoder is realized by an LSI and restricted in view of a cost, heat generation and mounting area. A processing load is heavy when realized by software, and limitation is applied by heat generation and the number and performance of mountable processors.

Accordingly, a GUI (Graphical User Interface) is desired in view of usability because encoding can be performed more than the number of encoders by using the limited number of encoders, a recording channel can be added, even when recording is being performed by using all the encoders, without stopping the encoding of such channels, and the above mechanism is easily understandable to the user and an operation can be made intuitively.

It is an object of the invention to improve the usability of the video encoding device.

The above object can be achieved by the invention described in the claims.

According to this construction, for example, more channels can be encoded at the same time by using a multichannel encoder having an upper limit in the number of channels that can be originally encoded at the same time. And, another recording channel can be added without stopping a recording channel. And, it becomes possible to perform the above operation intuitively and easily by the GUI.

According to the invention, the usability of the video encoding device can be improved.

Other objects, characteristics and advantages of the invention will become apparent from the description of an embodiment of the present invention related to the accompanying drawings.

### BRIEF DESCRIPTION OF THE DRAWINGS

FIG. 1 is a block diagram showing a structure of a video encoding device according to a first embodiment of the invention.

FIG. 2 is a block diagram showing a structure of an encoder 1401.

FIG. 3A is a diagram showing operation timing of the video encoding device according to the first embodiment of the invention.

FIG. 3B is a diagram showing operation timing of the video encoding device according to the first embodiment of the invention.

FIG. 3C is a diagram showing operation timing of the video encoding device according to the first embodiment of the invention.

FIG. 3D is a diagram showing operation timing of the video encoding device according to the first embodiment of the invention.

FIG. 4 is a flow chart showing judgment of reduction of a processing amount of the video encoding device according to the first embodiment of the invention.

FIG. 5A is a diagram showing a GUI of the video encoding device according to the first embodiment of the invention.

FIG. 5B is a diagram showing the GUI of the video encoding device according to the first embodiment of the invention.

FIG. 5C is a diagram showing the GUI of the video encoding device according to the first embodiment of the invention.

FIG. 5D is a diagram showing the GUI of the video encoding device according to the first embodiment of the invention.

FIG. 5E is a diagram showing the GUI of the video encoding device according to the first embodiment of the invention.

### DESCRIPTION OF THE INVENTION

An embodiment of the present invention will be described below with reference to the drawings.

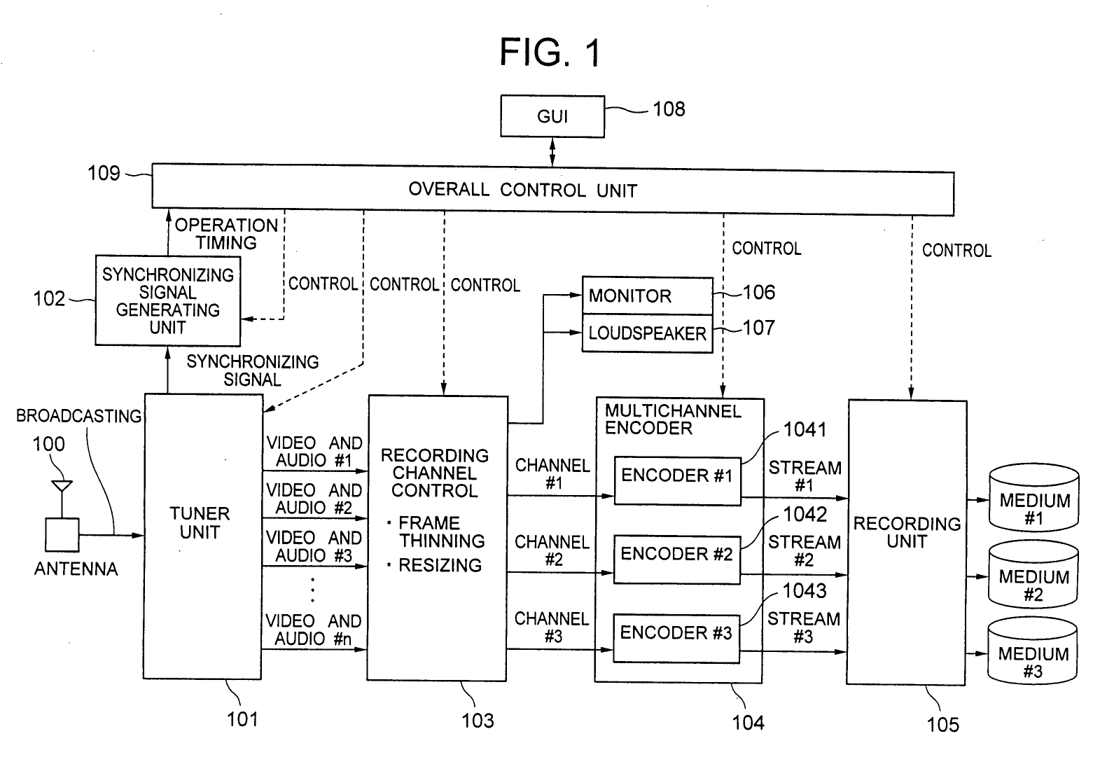

FIG. 1 shows a structure of the video encoding device (encoder) of the first embodiment of the invention.

This video encoding device is a device capable of simultaneously recording by compression encoding the selected programs of one or more channels in the received analog terrestrial broadcasting using a video encoding method such as, for example, MPEG-2 format and comprises an antenna 100, a tuner unit 101, a synchronizing signal generating unit 102, a recording channel control unit 103, a multichannel encoder 104, a recording unit 105, a monitor 106, a loudspeaker 107, a GUI 108, and an overall control unit 109.

Among them, the monitor 106 and the loudspeaker 107 are not essential but required only when a certain channel received by the tuner unit 10 is watched. The GUI 108 is also not essential but required when the overall control unit 109 is controlled interactively.

An analog TV airwave received by the antenna 100 is input to the tuner unit 101, where a tuned broadcast's audio and video signal and a video vertical and horizontal synchronizing signal are taken. The tuner unit 101 should be able to tune to a plurality of channels from a single analog TV airwave and output a pair of plural audio and video signals as a result. To realize this function, the tuner unit 101 may be configured to include a plurality of analog tuners.

The synchronizing signal generating unit 102 generates operation timing of the video encoding device from one pair or plural pairs of video vertical and horizontal synchronizing signals input from the tuner unit 101 and outputs to the overall control unit 109. It is because encoding must be performed in synchronization with a broadcast frame rate (30 frames/sec based on the NTSC system, 25 frames/sec based on the PAL system, etc.) to encode a broadcast in real time.

As a reference signal for a real-time encoding operation of a broadcast, it is appropriate to use the received broadcast vertical and horizontal synchronizing signals or other signals having the same cycles as those of such signals. The synchronizing signal generating unit 102 of the embodiment may select one from the input vertical and horizontal synchronizing signals or generate uniquely a signal having the same cycle within it.

The multichannel encoder 104 comprises a plurality of encoders 1041, 1042, 1043, . . . , encodes independently the input of analog broadcast audio and video signals of a plurality of systems, and outputs as an independent stream having video and audio multiplexed.

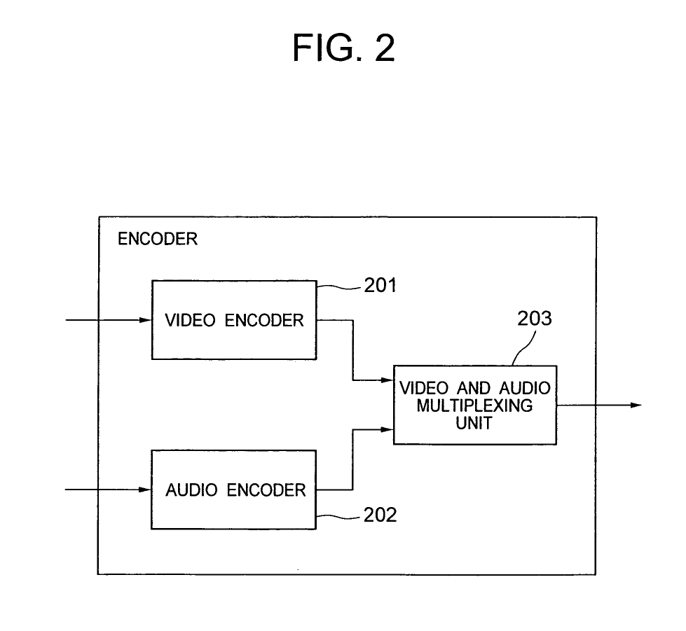

A structure of the encoder 1041 is shown in FIG. 2. The encoder 1041 has a video encoder 201, an audio encoder 202, and a video and audio multiplexing unit 203.

The video signal encoding method of the video encoder 201 may be MPEG-1 Video, MPEG-2 Video, MPEG-4 Video, H.264/AVC, or any other video encoding method. And, the audio signal encoding method of the audio encoder 202 may be MPEG-1 Audio, MPEG-2 Audio, G.726, or any other audio encoding method. Besides, a method of multiplexing video and audio by the video and audio multiplexing unit 203 may be MPEG-2 PS (Program Stream), MPEG-2 TS (Transport stream), or any other video and audio multiplexing method.

The recording unit 105 writes the video and audio multiplexed signal being output from the multichannel encoder 104 into a recording medium. The recording medium may be an optical disk such as BD (Blu-ray Disc) or DVD, a magnetic disk such as HDD, an nonvolatile semiconductor memory, an SDRAM, or any other storage medium. And, the video and audio multiplexed signals being input from a plurality of channels may be recorded into different recording media or one and same recording medium.

The monitor 106 and the loudspeaker 107 output video and audio of a single channel tuned by the tuner unit 101. The video and audio to be output may be a certain channel to be input to the multichannel encoder 103 or another channel to be input.

The GUI 108 mediates the overall control unit 109 and a user interface. Specifically, it plays a role to transmit the user instruction to the overall control unit 109 and to transmit information from the overall control unit 109 to the user. Details will be described later.

The overall control unit 109 controls the operations of the tuner unit 101, the synchronizing signal generating unit 102, the recording channel control unit 103, the multichannel encoder 104, and the recording unit 105.

The control of the tuner unit 101 includes, for example, selection of a frequency to be tuned, selection of a channel to be output to the recording channel control unit 103, and selection of a channel to be output to the monitor 106 and the loudspeaker 107.

The control to the synchronizing signal generating unit 102 is, for example, to generate operation timing by selecting any of the synchronizing signals to be input from the tuner unit 101 or to generate operation timing within it without selecting anything.

The control to the recording channel control unit 103 and the multichannel encoder 104 includes control of start and end of recording, the number of recording channels and the like. And, the control to the recording unit 105 is, for example, to determine that the video and audio multiplexed signals to be input from a plurality of channels are recorded into which address of which recording medium. Details of such control will be described below in connection with the roles of the GUI 108.

Now, the multichannel encoder 104 includes three encoders that can encode SDTV-size images according to the MPEG-2 system and should be able to encode 3-channel video and audio multiplexed signals independently in real time.

For MPEG-2 encoding, an input image is divided into a small region of 16 vertical pixels and 16 horizontal pixels, which is called as macroblocks, and one screen is encoded by sequentially performing the encoding processing starting from the left upper macroblock of the screen. Therefore, the processing amount required for encoding one screen is proportional to the number of macroblocks of the entire screen, namely an image size of an input image. Naturally, the processing amount is also proportional to a frame rate of the input image. Therefore, a processing amount of the encoder required for encoding a prescribed channel can be reduced by decreasing the image size or the frame rate of the input image.

Since the processing amount is reduced, this surplus performance can be exploited to perform additional encoding processing other than the prescribed three channels. Specifically, encoding of one additional channel (namely, transition from 3-channel encoding to 4-channel encoding) with the processing amount for three channels reduced by-the multichannel encoder which is encoding three SDTV channels will be described.

First, the following three are considered as ways of reducing the processing amount.
Existing processing of three channels is uniformly reduced, and the combined surplus performance is used for processing of a fourth channel (called as “mode A”).
Processing of particular one channel among the existing three channels is reduced, and the surplus performance is used to process a fourth channel (called as “mode B”).
Processing of particular one channel among the existing three channels is not reduced, but processing of the other channels is reduced, and the resulting surplus performance is used for processing of a fourth channel (called as “mode C”).

In order to realize the above, the following control is added to the recording channel control unit 103.

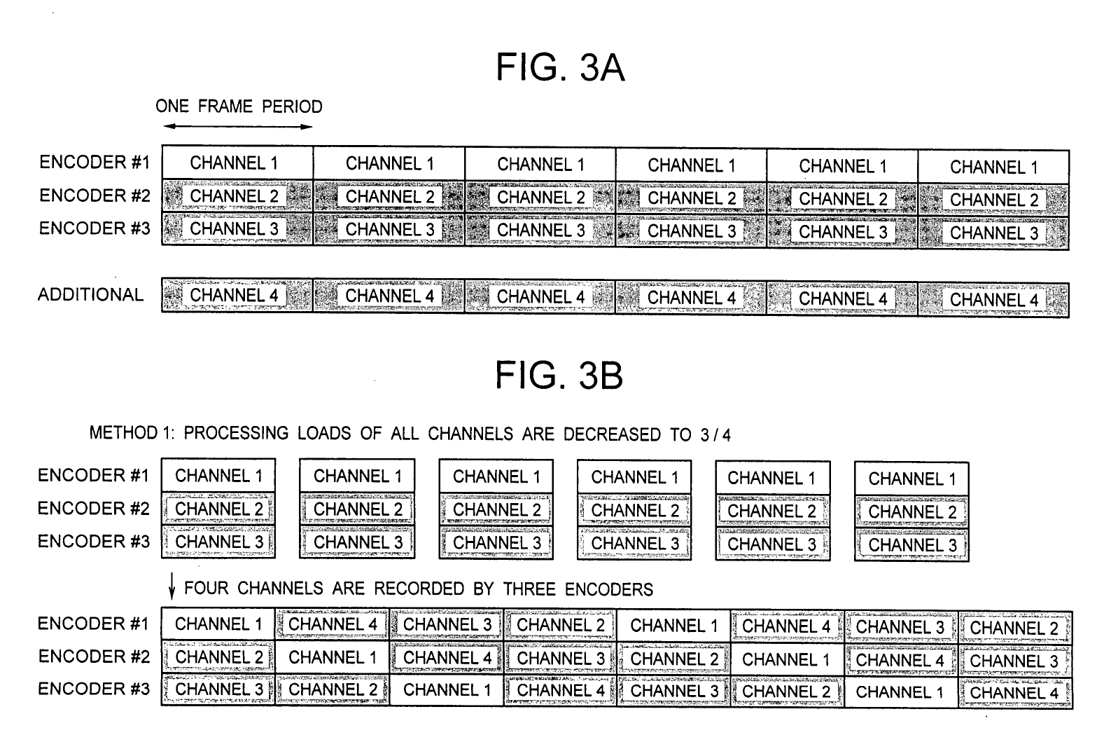

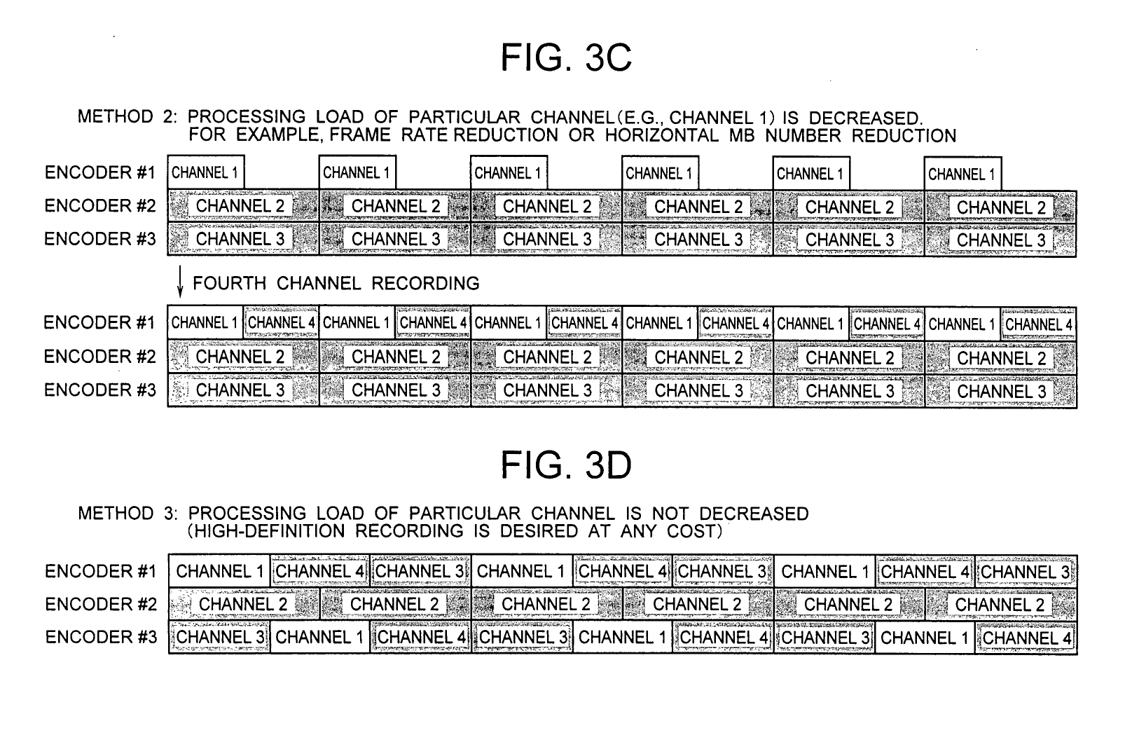

The content of the control will be described with reference to FIG. 3A through FIG. 3D. First, when the operation is performed in the mode A, the processing amount of channel 1, channel 2 and channel 3 is reduced to ¾. Specifically, a frame rate is reduced (from 30 frames/sec to 22.5 frames/sec) or an image size is reduced (from 720×480 pixels to 540×480 pixels) by the recording channel-control unit 103. As a result, the surplus performance for 3−(3×0.75)=0.75 channel is produced ((1) in FIG. 3B). Accordingly, for the additional channel 4, a frame rate is reduced or an image size is reduced in the same manner as that performed for the channels 1 through 3, and encoding of four channels becomes possible (FIG. 3-3).

Then, the operation in the mode B will be described. In the mode B, a processing amount of a particular channel (here, channel 1 is selected) is reduced to ½ ((1) in FIG. 3C). Specifically, a frame rate is changed from 30 frames/sec to 15 frames/sec, or an image size is changed from 720×480 to 360×480. Thus, a surplus for 0.5 channel is produced, so that encoding of four channels becomes possible by similarly reducing the processing amount of the additional channel 4 to ½ ((2) in FIG. 3C).

Besides, the operation in the mode C will be described. In the mode C, a processing amount of the channels other than a particular channel (here, channel 2) is reduced to ⅔. It can be realized by decreasing the frame rate from 30 frames/sec to 20 frames/sec or the image size from 720×480 to 480×480. Thus, a surplus for 0.66 channel is produced, so that encoding of four channels becomes possible by similarly reducing the processing amount of the additional channel 4 (FIG. 3D).

Allocation of the processing amounts in the above three examples is mere examples and does not restrict the invention.

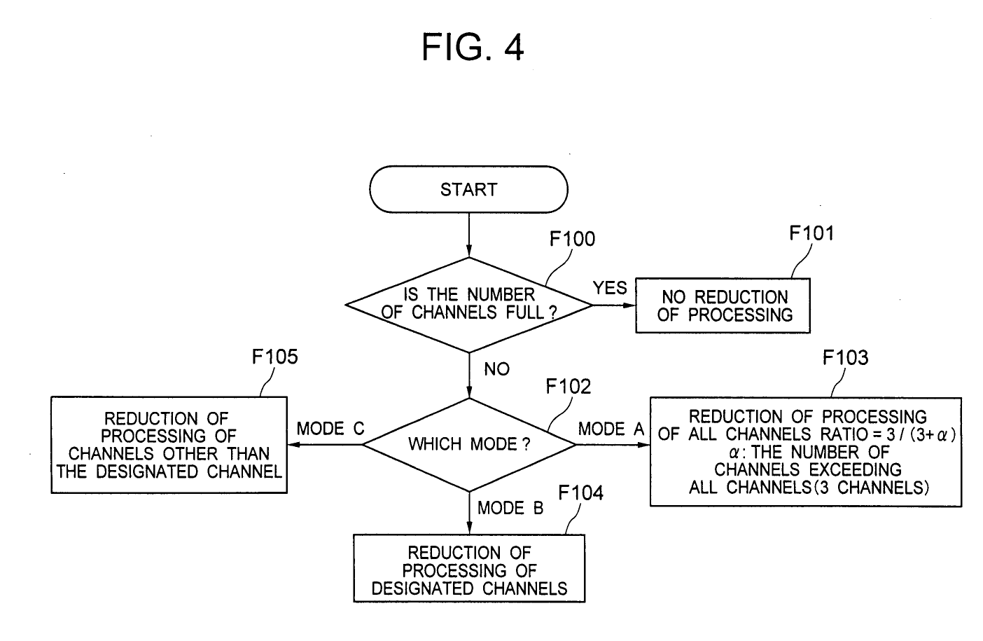

A flow for performing the above-described control in a case where the number of channels to be encoded changes will be described with reference to FIG. 4.

When the number of channels is changed, it is judged whether the encoding processing is not enough unless the processing amount is reduced or whether encoding can be performed without changing the processing amount (F100). If it is not necessary to change the processing amount, encoding is performed without any change (F101). If it is judged that the encoding processing is not enough unless the processing amount is reduced, a mode for reducing the processing amount is judged next (F102). When the mode A is selected, the processing amounts of all the channels are reduced (F103). When the mode B is selected, the processing amount of the designated channel is reduced (F104). When the mode C is selected, the processing amounts of the channels other than the designated channel are reduced. Specific methods for such processes are already described above.

In any of the above-described modes A through C, the recording channel control unit 103 and the multichannel encoder 104 must be controlled so that an empty resource can be used well in order to encode the four channels by a three-circuit encoder. In this case, points in controlling are three of (1) which encoder is used to encode (2) which channel in (3) what timing.

Restrictions in encoding control are following two.
According to the MPEG, information on the frame encoded immediately before might be used to encode the next frame (relations among an I picture, a P picture and a B picture). Therefore, different frames of the same channel might not be encoded simultaneously by a plurality of encoders.
The recording channel control unit 103 may be configured to have a frame memory for buffering the input frame, but it is desirable that a capacity of the frame memory is as small as possible. Therefore, it should be controlled not to process a particular channel preferentially but to process the number of channels to be processed equally.

It is seen from the above that in a case where the mode A is selected, the control may be performed as indicated by (2) in FIG. 3B. In other words, three different channels (channels 1 to 3 in FIG. 3B) are first allotted to three encoders. Processing of one frame is completed after a ¾ frame, so that a channel (channel 4 in FIG. 3B) not allocated first is preferentially allocated to the encoder in next timing. By controlling in this way, all the channels can be encoded equally.

In a case where the mode B and the mode C are selected, conventional control is conducted for a channel of which processing amount is not decreased (input is encoded as it is), and the same control as that in the mode A is conducted for the other channels ((2) in FIG. 3C, FIG. 3D).

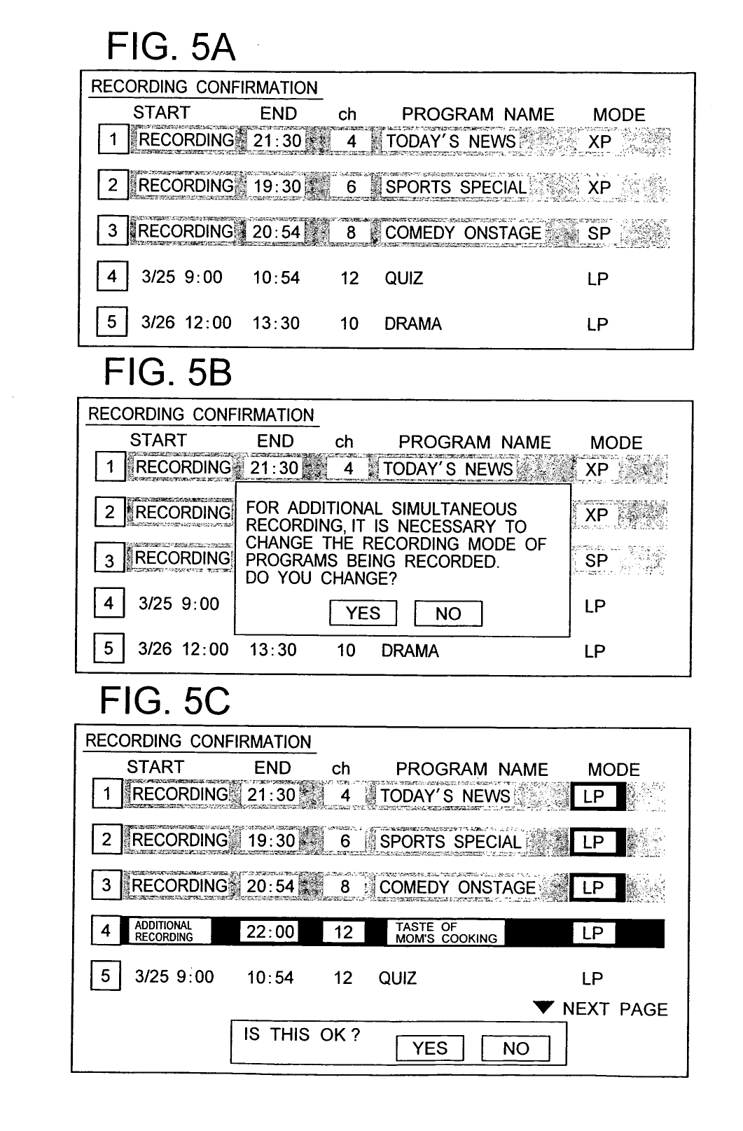

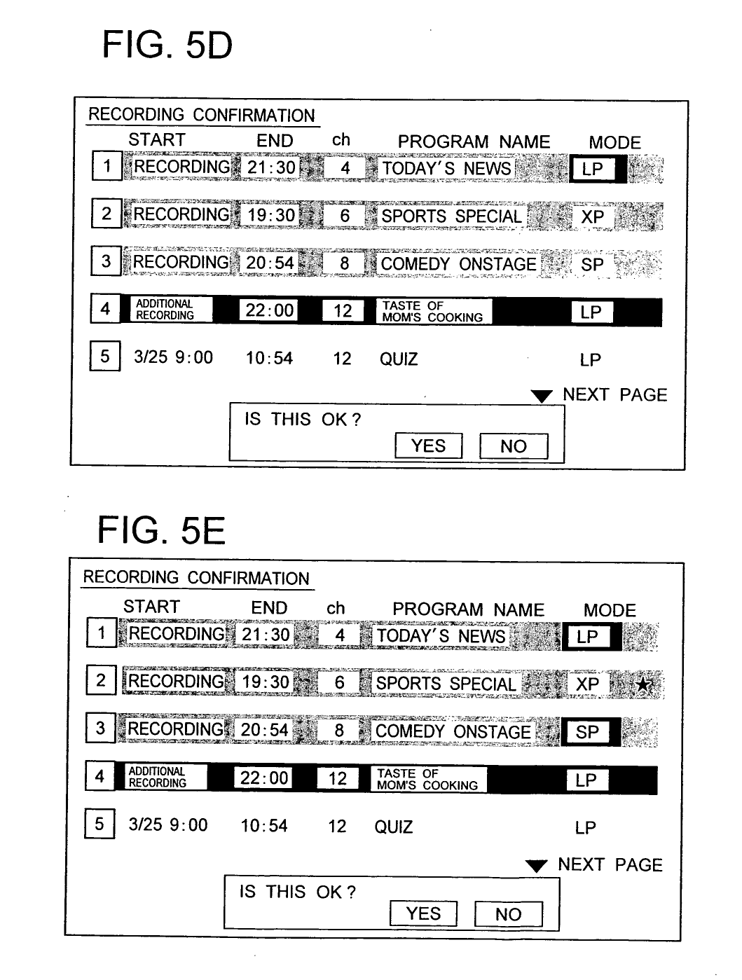

A GUI related to the processing amount-decreased modes (the above-described modes A to C) will be described below with reference to FIG. 5A to FIG. 5E.

In a case where 3 channels are being recorded, a recording confirmation screen shows a list of programs being recorded and those reserved for recording as shown in, for example, FIG. 5A. Here, when it is operated to record in addition and it is judged that the encoding processing is not sufficient unless the processing amount is decreased (F102 in FIG. 4), a recording mode change confirmation dialog is displayed as shown in FIG. 5B. Here, when the user selects “YES”, the overall control unit 109 first displays a candidate recording mode when the encoding processing is reduced in mode 1 (FIG. 5C). When the user selects “YES” here, the recording mode is changed, and simultaneous recording of four channels is started.

When “NO” is selected, the overall control unit 109 displays a candidate recording mode when the encoding processing is reduced in mode 2 (FIG. 5D). When the user selects “YES” here, the recording mode is changed, and simultaneous recording of four channels is started. When “NO” is selected, the overall control unit 109 displays a next candidate.

And, when a particular channel has a flag indicating prohibition of a recording mode change, the overall control unit 109 displays a candidate record mode of mode 3 (FIG. 5E). When the user selects “YES” here, the record mode is changed, and simultaneous recording of four channels is started.

According to the above method, a multichannel encoder, which could originally record only a fixed number of channels at the same time, can be used to record a larger number of channels at the same time.

The present invention may be applied to household and business video recording devices (HDD/DVD recorders and remote monitoring systems).

The above description was made with reference to the embodiment, but the present invention is not limited to it, and it is apparent for those skilled in the art that various changes and modifications may be made without departing from the spirit and scopes of the appended claims of the invention.

1. A video encoding device, comprising:
a capturing unit for capturing a plurality of video data;
a selecting unit for selecting video data to be recorded from the plurality of video data;
an encoding unit for encoding the video data selected by the selecting unit; and
a control unit for controlling to enable to encode additional video data by the encoding unit by reducing a processing load of the video data being encoded by the encoding unit when the selecting unit adds video data to be recorded while the encoding unit is encoding the video data selected by the selecting unit.

2. The video encoding device according to claim 1, wherein the reduction of the processing load of the video data controlled by the control unit is to reduce a size of the video data and/or to lower a frame rate of the video data.

3. The video encoding device according to claim 1, wherein the capturing unit is a tuner unit which tunes to an airwave received by an antenna and outputs video data.

4. The video encoding device according to claim 2, wherein the capturing unit is a tuner unit which tunes to an airwave received by an antenna and outputs video data.

5. The video encoding device according to claim 1, wherein the control unit reduces substantially equally processing loads of the plurality of video data when video data to be recorded is added by the selecting unit while the plurality of video data are being encoded by the encoding unit.

6. The video encoding device according to claim 2, wherein the control unit reduces substantially equally processing loads of the plurality of video data when video data to be recorded is added by the selecting unit while the plurality of video data are being encoded by the encoding unit.

7. The video encoding device according to claim 3, wherein the control unit reduces substantially equally processing loads of the plurality of video data when video data to be recorded is added by the selecting unit while the plurality of video data are being encoded by the encoding unit.

8. The video encoding device according to claim 4, wherein the control unit reduces substantially equally processing loads of the plurality of video data when video data to be recorded is added by the selecting unit while the plurality of video data are being encoded by the encoding unit.

9. The video encoding device according to claim 1, wherein:
an operation unit for designating video data of which processing load is decreased is disposed; and
the control unit reduces a processing load of video data designated by the operation unit when video data to be recorded is added by the selecting unit while the plurality of video data are being encoded by the encoding unit.

10. The video encoding device according to claim 2, wherein:
an operation unit for designating video data of which processing load is decreased is disposed; and
the control unit reduces a processing load of video data designated by the operation unit when video data to be recorded is added by the selecting unit while the plurality of video data are being encoded by the encoding unit.

11. The video encoding device according to claim 3, wherein:
an operation unit for designating video data of which processing load is decreased is disposed; and
the control unit reduces a processing load of video data designated by the operation unit when video data to be recorded is added by the selecting unit while the plurality of video data are being encoded by the encoding unit.

12. The video encoding device according to claim 4, wherein:
an operation unit for designating video data of which processing load is decreased is disposed; and
the control unit reduces a processing load of video data designated by the operation unit when video data to be recorded is added by the selecting unit while the plurality of video data are being encoded by the encoding unit.

13. The video encoding device according to claim 1, wherein:
an operation unit for designating video data of which processing load is not decreased is disposed; and
the control unit reduces a processing load of video data other than the video data designated by the operation unit when video data to be recorded is added by the selecting unit while the plurality of video data are being encoded by the encoding unit.

14. The video encoding device according to claim 2, wherein:
an operation unit for designating video data of which processing load is not decreased is disposed; and
the control unit reduces a processing load of video data other than the video data designated by the operation unit when video data to be recorded is added by the selecting unit while the plurality of video data are being encoded by the encoding unit.

15. The video encoding device according to claim 3, wherein:
an operation unit for designating video data of which processing load is not decreased is disposed; and
the control unit reduces a processing load of video data other than the video data designated by the operation unit when video data to be recorded is added by the selecting unit while the plurality of video data are being encoded by the encoding unit.

16. The video encoding device according to claim 4, wherein:
an operation unit for designating video data of which processing load is not decreased is disposed; and
the control unit reduces a processing load of video data other than the video data designated by the operation unit when video data to be recorded is added by the selecting unit while the plurality of video data are being encoded by the encoding unit.
